(19) United States
(12) Patent Application Publication
(10) Pub. No.: US 2025/0304853 A1
(43) Pub. Date: Oct. 2, 2025

(54) BIOLOGICAL SLICKWATER FLUIDS AND METHODS OF USE THEREOF IN CONJUNCTION WITH SUBTERRANEAN OPERATIONS

(71) Applicant: SAUDI ARABIAN OIL COMPANY, Dhahran (SA)

(72) Inventors: Murtadha J. ALTAMMAR, Dhahran (SA); Abeer A. ALARAWI, Dhahran (SA); Ameerah M. BOKHARI, Dhahran (SA)

(73) Assignee: SAUDI ARABIAN OIL COMPANY, Dhahran (SA)

(21) Appl. No.: 18/619,515

(22) Filed: Mar. 28, 2024

(51) Int. Cl. C09K 8/68; C09K 8/54; C09K 8/60; C09K 8/88

(52) U.S. Cl. CPC C09K 8/68; C09K 8/54; C09K 8/602; C09K 8/882; C09K 2208/28; C09K 2208/32

(57) ABSTRACT

Slickwater fracturing fluids comprising one or more enzymes, one or more organisms capable of generating the one or more enzymes, or any combination thereof, may increase hydrocarbon production from a subterranean formation. In an aspect, slickwater fracturing fluids may comprise: an aqueous fluid, the enzymes, the organisms, or any combination thereof; proppant particulates; a friction reducer; and optionally, one or more additives. In an aspect, methods may comprise introducing the slickwater fracturing fluid into a subterranean formation; and contacting the slickwater fracturing fluid with a matrix of the subterranean formation. In an embodiment, methods may comprise introducing the slickwater fracturing fluid to the subterranean formation at a pressure and/or a flow rate sufficient to create and/or enlarge one or more fractures in the subterranean formation, and to force the slickwater fracturing fluid into the one or more fractures in the subterranean formation.

### FIELD OF THE DISCLOSURE

The present disclosure relates generally to subterranean operations and, more particularly, subterranean stimulation operations employing slickwater fluids to increase production from subterranean formations.

### BACKGROUND OF THE DISCLOSURE

Hydrocarbons such as crude oil and natural gas are produced from oil and gas wells within hydrocarbon reservoirs with porous/permeable walls. Unconventional hydrocarbon reservoirs are reservoirs with containing hydrocarbons (e.g., oil and natural gas) trapped by a formation matrix having low permeability. Methods for increasing hydrocarbon mobility may involve hydraulic fracturing, in which a hydraulic fracturing fluid is flowed through the reservoir at high pressure and a high flow rate, such that a fracture net pressure of the subterranean formation is exceeded. The high pressure fractures the matrix of the subterranean formation to increase hydrocarbon mobility by increasing permeability of the matrix.

Some hydrocarbon reservoirs include an organic material called kerogen intertwined with the formation matrix, which can drastically increase the tensile strength of the formation matrix. As a result, significant energy can be required to propagate fractures in these types of reservoirs. Diverting fracturing is a common method for increasing the permeability of previously fractured reservoirs by filling initial fractures with proppant particulates (e.g., sand) to hold the fractures open, thereby raising the internal pressure of the reservoir to promote opening of new fractures. One popular diverting fracturing technique is slickwater fracturing, which injects a mixture of chemicals, water, and proppant into a formation (e.g., an oil or gas well). Low-viscosity slickwater is commonly used to improve fracture conductivity in ultra-tight formations, such as shale formations. Slickwater fracturing fluids are distinguished from viscosified fracturing fluids, which utilize a viscosifying polymer to facilitate transport of proppant particulates.

Hydraulic fracturing operations have been performed with additives that disintegrate kerogen and/or other organic matter within hydrocarbon reservoirs, thus increasing permeability of the formation matrix to increase hydrocarbon production via the generated fractures. The heterogeneous kerogen matrix consists of building blocks composed of large alkyl and alkenyl fragments joined by resorcinol units. Kerogens may differ based on the type of subterranean formation in which they are located. For example, kerogen in shale formations is primarily an aliphatic-branched macromolecule crosslinked with aromatic, usually phenolic, units and differently bonded oxygen atoms in various ratios. Standard degradation methods, which cleave kerogen into lower molecular weight compounds, may occur at high temperatures (e.g., pyrolysis) or with chemicals (e.g., acids, bases, oxidants) at high or low temperatures. The amount of soluble kerogen in a sediment depends on the solvent used, the extraction conditions, and the physical and chemical properties of the sediment itself. The solvent power is dependent on its physical and chemical properties and the temperature used. Acids and bases may dissolve non-kerogen portions of shale such as carboxylic acids and their analogs (unbranched aliphatic acids, branched acids, dicarboxylic acids, keto acids, and aromatic acids), while oxidants may dissolve kerogens and produce fractures within shale formations. However, these treatments may be unsustainable, toxic, explosive, or only partially effective. Pyrolysis, for example, decomposes organic matter into non-condensable gases, condensable liquids, and solid residue, biochar, or charcoal, which may cause large CO₂ emissions. Chemical treatments, such as oxidants, are often not environmentally friendly.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments consistent with the present disclosure, slickwater fracturing fluid methods comprise: introducing a slickwater fracturing fluid into a subterranean formation, wherein the slickwater fracturing fluid comprises an aqueous fluid; one or more enzymes, one or more organisms capable of generating the one or more enzymes, or any combination thereof, wherein the one or more enzymes are capable of increasing hydrocarbon production from the subterranean formation; proppant particulates; a friction reducer; and optionally, one or more additives; and contacting the slickwater fracturing fluid with a matrix of the subterranean formation.

According to further embodiments consistent with the present disclosure, slickwater fracturing fluid compositions comprise: an aqueous fluid; one or more enzymes, one or more organisms capable of generating the one or more enzymes, or any combination thereof, wherein the one or more enzymes are capable of increasing hydrocarbon production from the subterranean formation; proppant particulates; a friction reducer; and optionally, one or more additives.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Not applicable.

### DETAILED DESCRIPTION

Embodiments in accordance with the present disclosure generally relate to subterranean operations and, more particularly, subterranean stimulation operations employing slickwater fluids to increase production from subterranean formations.

In the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description.

In response to the difficulties associated with stimulating a subterranean formation via slickwater fracturing, such as a shale formation, the present disclosure provides slickwater fracturing fluids comprising a biological agent (e.g., one or more enzymes and/or one or more organisms capable of producing such enzymes) and a proppant. Slickwater fracturing fluids of the present disclosure may provide advantages over alternative approaches for addressing kerogen and other organic matter in a subterranean formation. Biological agents may avoid the environmental issues commonly associated with conventional oxidizing agents and the carbon dioxide release associated with pyrolysis. Additionally, biological agents may be applicable to sediments containing low concentrations of kerogen and other organic matter, whereas alternative processes may not.

As used herein, the term “subterranean formation,” and grammatical variants thereof, refer to naturally occurring rock beneath the Earth's surface, including subsea surfaces. As used herein, the terms “formation matrix,” “matrix,” and grammatical variations thereof, refer to the variety of natural rock which makes up a subterranean formation, including, but not limited to, carbonate-based rock (e.g., calcium carbonate (CaCO₃)), calcium magnesium carbonate (CaMg(CO₃)₂) (also referred to as dolomite), sandstone-based rock comprising clays (e.g., smectite, illite, kaolinite, chlorite, and the like), each of which include minerals (e.g., siliceous material) the like, and any combination thereof. The subterranean formations described herein encompass reservoir zones (i.e., zones comprising hydrocarbons, also referred to herein as “hydrocarbon reservoirs”) and non-reservoir zones (i.e., zones that do not include hydrocarbons, such as water-producing zones). Suitable subterranean formations, or a hydrocarbon reservoir contained therein, may comprise kerogen or other organic matter that may impede reservoir conductivity. Examples of suitable subterranean formations include, but are not limited to, shales, cherts, marls, and the like. The kerogens present in a subterranean formation are not particularly limited and may differ depending on the type of subterranean formation undergoing stimulation according to the disclosure herein.

As used herein, the terms “subterranean operation” and “upstream operation,” and grammatical variants thereof, refer to any operation (e.g., drilling, completion, stimulation, enhanced recovery, production, and waste storage) involved in production of petroleum, natural gas, as well as other resources, such as water or helium, from a subterranean formation. A subterranean formation may contain an existing injection well, an existing production well, a deep abandoned shallow single and/or multi-lateral well.

As used herein, the terms “well”, “wellbore,” and grammatical variants thereof, refer to a drilled hole or borehole penetrating a subterranean formation, which may be cased (cemented) or uncased (open hole).

As used herein, the term “slickwater fluid,” and grammatical variants thereof, refers generally to any non-viscosified fluid designed or suitable for use in a subterranean operation to achieve a desired purpose. A “slickwater fracturing fluid” may be configured to perform a fracturing operation with a subterranean formation of a specified type (e.g., a slickwater fracturing fluid may be a slickwater fluid further comprising proppant particulates, a friction reducer, and optional chemicals or additives).

Hydraulic fracturing operations may generate various pressures at various locations within a wellbore and/or within a formation fluidically connected to the wellbore, e.g., a fracture net pressure. As used herein, the term “fracture net pressure,” and grammatical variations thereof, generally refers to the excess pressure in a slickwater fracturing fluid inside a fracture (i.e., in excess of the pressure required to simply keep the fracture open). As used herein, a fracture net pressure may be defined by units of pounds per square inch (“psi”), bar, kilopascal (“kPa”), or the like.

As used herein, the term “biological agent,” and grammatical variants thereof, refers to an enzyme of the present disclosure, or an organism of the present disclosure capable of generating said enzyme.

As used herein, the term “enzyme,” and grammatical variants thereof, refers to a protein capable of acting as a biological catalyst to accelerate a chemical reaction, or a domain thereof possessing said catalytic activity. As used herein, an enzyme may be generated by an organism selected from the group consisting of prokaryotes, such as bacteria or archaea, or eukaryotes, such as plants, fungi, animals, or single cell protists. In one embodiment, an enzyme may be generated by an organism selected from the group consisting of bacteria, fungi, or yeast. An enzyme may act as a catalyst within, in proximity to, or upon isolation from said organism. An enzyme may be a naturally derived or an artificial enzyme. As used herein, the term “naturally derived enzyme,” and grammatical variants thereof, refers to an enzyme isolated from the organism which generated the enzyme. As used herein, the term “artificial enzyme,” and grammatical variations thereof, refers to a synthesized enzyme having the same or a similar chemical structure to a naturally derived enzyme.

Subterranean formations in which slickwater fracturing fluids of the present disclosure may be used to conduct a fracturing or similar stimulation operation are not believed to be especially limited. In non-limiting examples, suitable subterranean formations may include, but are not limited to, saline aquifers (e.g., sandstones), oil reservoirs (e.g., for enhanced oil recovery and carbon storage), as well as unconventional formations (e.g., shale formations), or the like.

Slickwater fluids of the present disclosure may be used in various subterranean operations. Nonlimiting examples of subterranean operations for which a slickwater fluid may be designed and used include enhanced oil recovery operations (e.g., water, chemical, or gas flooding operations), fracturing operations, acidizing operations, gravel-packing operations, or the like, or any combination thereof. In some embodiments, slickwater fluids of the present disclosure may be designed for an enhanced oil recovery operation. Enhanced oil recovery operations may be CO₂ flooding operations, CO₂ huff-and-puff operations, or the like, where CO₂ is replaced or supplemented by slickwater fluids of the present disclosure.

In some embodiments, slickwater fluids may comprise slickwater fracturing fluids suitable for performing hydraulic fracturing. Slickwater fracturing fluids of the present disclosure may comprise a low viscosity aqueous fluid, chemicals, and proppant particulates (e.g., sand or other suitable particulate materials)). Slickwater fracturing fluids suitable for performing hydraulic fracturing may be plug-and-perf fluids (e.g., hydraulic fracturing slickwater fracturing fluids designed for injection into subterranean formations via a perforated and isolated well casing). Slickwater fracturing fluids of the present disclosure may be suitable for refracturing of subterranean formations (e.g., for injection into previously fractured subterranean formations in which productivity has decreased over time).

The slickwater fracturing fluids as described herein may comprise aqueous-based fluids. Suitable aqueous-based fluids may include fresh water, saltwater, brine, seawater, wastewater, purified wastewater, the like, or any combination thereof. The slickwater fracturing fluids may include various components suitable for use in a particular subterranean formation operation.

Slickwater fracturing fluids of the present disclosure may further comprise one or more additives suitable for a particular subterranean operation. Slickwater fluids of the present disclosure may comprise proppant particles, a friction reducer, and optionally, one or more additives. In one embodiment, slickwater fluids of the present disclosure are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, the like, and any combination thereof.

Slickwater fracturing fluids of the disclosure may include breakers that may degrade gelling polymers or other viscosified fluids within the subterranean formation. Suitable breakers include acid breakers, bacteria-based breakers, enzyme-based breakers, oxidative breakers, the like, and any combination thereof. Common polymers broken by a breaker include guar, hydroxypropyl guar, xanthan gum, the like, and any combination thereof. The breakers may be encapsulated or not encapsulated. When used, breakers may be present in the slickwater fracturing fluid in a range from about 0.003 wt. % to about 1.3 wt. %, based on the total weight of the slickwater fracturing fluid.

The present disclosure provides slickwater fracturing fluids comprising one or more biological agents that may increase production from a subterranean formation, as well as associated methods for using the same in conjunction with a stimulation operation, such as a fracturing or acid fracturing operation. More specifically, slickwater fracturing fluids of the present disclosure may comprise one or more enzymes, one or more organisms capable of generating the one or more enzymes, or any combination thereof, wherein the enzymes are capable of increasing hydrocarbon production from a subterranean formation. In one example embodiment, suitable enzymes are active within a pH range of from about 5 to about 9. In one example embodiment, an acidic pH may accelerate the activity of one or more of the enzymes. In one example embodiment, the slickwater fracturing fluid comprises one or more of the enzymes and an acidifying agent, e.g., an acid or an acidic buffer, which accelerates the activity of the enzyme(s).

The one or more enzymes, or the one or more organisms capable of generating said enzymes, of the present disclosure may be capable, within a subterranean formation, of acting on kerogen and/or other organic material, thus increasing hydrocarbon mobility therein. An enzyme capable of acting on kerogen and/or other organic matter may dissolve or disintegrate kerogen and/or other organic material. As used herein, the terms “degrade” and “disintegrate,” and grammatical variants thereof, of “kerogen and/or other organic matter,” refer to the reaction of kerogen and/or other organic matter with a slickwater fluid of the present disclosure, whereby the kerogen and/or other organic matter undergoes a decomposition reaction. Enzymatic degradation of kerogen and/or other organic matter within a subterranean formation may form lower molecular weight compounds. The degradation or disintegration of kerogen may produce gases, and this may further promote fracturing of the subterranean formation. The degradation or disintegration of kerogen may increase the porosity of the subterranean formation and may increase the subterranean formation's conductivity.

In non-limiting embodiments, the one or more enzymes may comprise at least one enzyme selected from the group consisting of a laccase, a hydrolase, an oxodoreductase, a lipase, the like, and any combination thereof. Laccase enzymes are multicopper oxidases commonly used in oxidative degradation and removal of phenolic compounds such as methoxyphenols and polycyclic aromatic hydrocarbons (PAHs), as well as non-phenolic compounds such as aromatic amines, aryl amines, anilines, thiols, dyes and pesticides. Hydrolytic enzymes (hydrolases) are among the common enzymes that can break macromolecules in a given organic matter into monomers. These enzymes are either produced outside microbial cells in the surrounded medium or are attached to the microbial cell surface. Suitable examples of hydrolytic enzymes include, but are not limited to, the like, and any combination thereof. Oxidoreductases are a group of enzymes including peroxidase, reductase, dehydrogenase, oxidase, oxygenase, and hydroxylase, and are involved in both aerobic and anaerobic metabolic reactions. These enzymes catalyze oxidoreduction reactions involving electron transfer in molecules. Oxidoreductases enzymes are used for degradation of organic matter and contaminants due to their strong oxidative traits, broad substrate specificity, and low energy consumption. Lipase enzymes are considered as hydrolases enzymes involved in lipid metabolism. These enzymes are the most abundantly used industrial enzymes due to their capability in degrading organic matter and heavy oil remediation and bioengineering processes at large. In an embodiment, degrading kerogen and/or other organic matter within a subterranean formation by one or more of the lipase enzymes may form lower molecular weight compounds.

Slickwater fracturing fluids of the present disclosure may comprise one or more living organisms capable of generating the one or more of the enzymes of the present disclosure, e.g., enzymes capable of degrading, disintegrating, or dissolving kerogen and/or other organic matter within a subterranean formation. Suitable organisms may be capable of biosynthesis and secretion of the one or more enzymes in a sufficient amount to achieve the benefits described herein. Examples of suitable organisms include, but are not limited to, bacteria, fungi, yeast, the like, or any combination thereof. Examples of suitable bacteria which generate enzymes capable of acting on kerogen and/or other organic material in a subterranean formation include, but are not limited to, Actinobacteria, Pseudomonas, Mycobacterium, Sphingomonas, Bacillus, Achromobacter the like, and any combination thereof. Examples of suitable fungi which generate enzymes capable of acting on kerogen and/or other organic material in a subterranean formation include, but are not limited to, Phanerochaete, Trametes, Bjerkandera, and Pleurotus, the like, and any combination thereof.

Slickwater fracturing fluids may further comprise one or more enzymes, or the one or more organisms capable of generating said enzymes, where said enzymes are capable, within a subterranean formation, of acting on other compounds, such as formates, carbon dioxide (CO₂), or the like, to convert said compounds into gases and/or hydrocarbons. In an embodiment, enzymes of the present disclosure may be capable of converting formates or CO₂ into gases, e.g., methane. The production of gases may further fracture the subterranean formation or may comprise hydrocarbons that supplement those already present within the subterranean formation. Examples of suitable enzymes capable of acting on formates and CO₂ to generate hydrocarbons may include, but are not limited to, a carboxylase, a decarboxylase, a dehydrogenase (e.g., formate dehydrogenase), a methanogen-specific enzymes (e.g., methyl-coenzyme M reductase), the like, and any combination thereof.

Slickwater fracturing fluids may further comprise one or more enzymes, or the one or more organisms capable of generating said enzymes, where said enzymes are capable, within a subterranean formation, of adsorbing or sequestering CO₂, or the like, thus increasing carbon storage therein. Advantages of the enzymes and/or organisms of the present disclosure over biological (e.g., thermal and/or chemical) treatments include the speed and safety of pumping biological-based treatments, better environmental favorability, and selective treatment targeting organic and/or inorganic matter. Examples of suitable enzymes for CO₂ sequestration may include, but are not limited to, carbonic anhydrase, Rubisco enzyme, pyruvate decarboxylase, pyruvate dehydrogenase, and the like.

Slickwater fracturing fluids of the present disclosure may comprise various types and quantities of the one or more enzymes present therein. In an embodiment, a slickwater fracturing fluid may comprise about 0.01 weight percent (wt. %) to about 10 wt. %, of the one or more enzymes, including all wt. % values and ranges therebetween (e.g., from about 0.01 wt. % to about 1 wt. %, from about 0.1 wt. % to about 2 wt. %, from about 1 wt. % to about 6 wt. %, or from about 5 wt. % to about 10 wt. %)

Slickwater fracturing fluid of the present disclosure may comprise one or more oxidants capable of increasing hydrocarbon production from a subterranean formation. In an embodiment, suitable oxidants may be capable of acting on kerogen and/or other organic matter within a subterranean formation to achieve the benefits described above. In an embodiment, one or more of the oxidants may be capable of dissolving, degrading, or disintegrating kerogen, other organic matter, the like, or any combination thereof, within the subterranean formation. In an embodiment, degrading kerogen, other organic matter, the like, or any combination thereof, within a subterranean formation by one or more of the oxidants may form lower molecular weight compounds.

Oxidants for acting on kerogen, other organic matter, the like, or any combination thereof, within a subterranean formation include, but are not limited to oxidizing acids, oxygen, ozone, oxides, halogens, halides, halogen oxyanions, peroxides, persulfates, permanganates, periodates, percarbonates, perborates, tetraborates, chromates, bromates, nitrates, nitrites, bismuthates, the like, and any combination thereof. Suitable examples of oxidizing acids include, but are not limited to, perchloric acid, nitric acid, iodic acid, chromic acid, dichromic acids, chromium trioxide, sulfuric acids (e.g., peroxydisulfuric acid, peroxymonosulfuric acid), the like, and any combination thereof. Suitable examples of oxides include, but are not limited to, nitrous oxide, nitrogen dioxide, dinitrogen tetroxide, ruthenium tetroxide, lead dioxide, the like, and any combination thereof.

Suitable examples of halogens include fluorine, chlorine, bromine, other halogens, and any combination thereof. Suitable examples of halides include, but are not limited to fluorides of chlorine, bromine and iodine. Suitable examples of halogen oxyanions include, but are not limited to, hypochlorites (e.g., sodium hypochlorite), chlorites (e.g., sodium chlorite), chlorates, perchlorates, bromates (e.g., sodium bromate), iodates, the like, and any combination thereof. Suitable examples of chlorates include, but are not limited to, alkali metal (e.g., lithium, sodium, potassium) chlorates, alkaline earth metal (e.g., magnesium, calcium strontium, barium) chlorates, the like, and any combination thereof. Suitable examples of bromates include, but are not limited to, alkali metal (e.g., lithium, sodium, or potassium) bromates, alkaline earth metal (e.g., magnesium, calcium strontium, barium) bromates the like, and any combination thereof.

Suitable examples of peroxides include, but are not limited to, hydrogen peroxide, inorganic peroxides (e.g., magnesium peroxide, calcium peroxide), the like, and any combination thereof. Suitable examples of persulfates include, but are not limited to, alkali metal (e.g., lithium, sodium, or potassium) persulfates, ammonium persulfate, the like, and any combination thereof. Suitable examples of permanganates include, but are not limited to, alkali metal (e.g., lithium, sodium, or potassium) permanganates, the like, and any combination thereof. Suitable examples of percarbonates include, but are not limited to, alkali metal (e.g., sodium) percarbonates, the like, and any combination thereof. Suitable examples of perborates include, but are not limited to, alkali metal (e.g., lithium, sodium, or potassium) perborates, the like, and any combination thereof.

Suitable examples of tetraborates include, but are not limited to, alkali metal (e.g., sodium) tetraborate, the like, and any combination thereof. Suitable examples of chromates include, but are not limited to, hexavalent chromium compounds (e.g., pyridinium chlorochromate), chromate/dichromate compounds (e.g., sodium dichromate), the like, and any combination thereof. Suitable examples of nitrates include, but are not limited to, alkali metal (e.g., lithium, sodium, or potassium) nitrates, ceric ammonium nitrate, the like, and any combination thereof. Suitable examples of nitrites include, but are not limited to, alkali metal (e.g., sodium) nitrites, the like, and any combination thereof. Suitable examples of bismuthates include, but are not limited to, alkali metal (e.g., lithium, sodium, or potassium) bismuthates, the like, and any combination thereof. In an embodiment, an oxidant for acting on kerogen, other organic matter, the like, or any combination thereof, within a subterranean formation is selected from the group consisting of sodium bromate, ammonium persulfate, the like, and any combination thereof.

When the one or more oxidants are used, slickwater fracturing fluids of the present disclosure may comprise various types and quantities of the one or more oxidants. In an embodiment, slickwater fracturing fluids comprises from about 1 pounds per thousand gallons (pptg) to about 100 pptg, of the one or more oxidants, including all pptg values and ranges therebetween (e.g., from about 5 pptg to about 100 pptg, or from about 10 pptg to about 50 pptg).

As referenced above, slickwater fracturing fluids may be utilized to enhance production from a subterranean formation, preferably by creating or enlarging one or more fractures within the matrix of a subterranean formation. Such methods may be accomplished by introducing the slickwater fracturing fluid into the subterranean formation at a pressure and/or a flow rate sufficient to exceed a fracture net pressure of the subterranean formation.

Accordingly, methods of the present disclosure may comprise: introducing a slickwater fracturing fluid of the present disclosure into a subterranean formation; and contacting the slickwater fracturing fluid with a matrix of the subterranean formation. The matrix may further comprise kerogen or other organic matter that may be dissolved or disintegrated by the one or more enzymes and/or organisms capable of generating said enzymes present in the slickwater fracturing fluids. The matrix may further comprise formates or CO₂ that may be converted into hydrocarbons by the one or more enzymes and/or organisms capable of generating said enzymes present in the slickwater fracturing fluids. Such methods may stimulate a greater hydrocarbon production from the subterranean formation, as compared to the method using a slickwater fracturing fluid lacking the one or more enzymes, the one or more organisms capable of generating the one or more enzymes, or any combination thereof. In some embodiment, the methods of the present disclosure may stimulate about 1% to about 50% greater subterranean formation performance, including all % values and ranges therebetween, as compared to a method performed with a corresponding slickwater fracturing fluid lacking the one or more enzymes and/or the one or more organisms. The matrix may further comprise CO₂ that may be absorbed or sequestered by the one or more enzymes and/or organisms capable of generating said enzymes present in the slickwater fracturing fluids. Such methods may stimulate greater carbon storage within the matrix of the subterranean formation.

Introducing the slickwater fracturing fluid into the subterranean formation may occur at a pressure and a flow rate sufficient to create and/or enlarge one or more fractures in the subterranean formation, and to force the slickwater fracturing fluid into the one or more fractures in the subterranean formation. In an embodiment, the slickwater fracturing fluid is introduced into the formation at a pressure and/or a flow rate sufficient to exceed a fracture pressure gradient of the matrix of the subterranean formation. The pressure and/or the flow rate sufficient to create and/or enlarge one or more fractures in the subterranean formation is well and formation dependent. In an embodiment, methods of the present disclosure may require a lower pressure and/or flow rate than a method performed with a corresponding slickwater fracturing fluid lacking the one or more enzymes, the one or more organisms capable of generating the one or more enzymes, or any combination thereof.

Contacting or injecting the slickwater fracturing fluid may comprise contacting or injecting the slickwater fracturing fluid into a separate portion of the subterranean formation from a production portion. Contacting or injecting the slickwater fracturing fluid may comprise contacting or injecting the slickwater fracturing fluid into the same portion of the subterranean formation as the production portion. Contacting or injecting the slickwater fracturing fluid may occur concurrently with production or contacting or injecting may be followed by a soaking period prior to production.

### Example Embodiments

Embodiments disclosed herein include:

A. Slickwater fracturing methods. The methods comprise: introducing a slickwater fracturing fluid into a subterranean formation, wherein the slickwater fracturing fluid comprises: an aqueous fluid; one or more enzymes, one or more organisms capable of generating the one or more enzymes, or any combination thereof, wherein the one or more enzymes are capable of increasing hydrocarbon production from the subterranean formation; proppant particulates; a friction reducer; and optionally, one or more additives; and contacting the slickwater fracturing fluid with a matrix of the subterranean formation.

B: Slickwater fracturing fluids. The fluids comprise: an aqueous fluid; one or more enzymes, one or more organisms capable of generating the one or more enzymes, or any combination thereof, wherein the one or more enzymes are capable of increasing hydrocarbon production from the subterranean formation; proppant particulates; a friction reducer; and optionally, one or more additives.

Each of Embodiments A and B may have one or more of the following additional elements in any combination.

Element 1: wherein the one or more additives are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, and any combination thereof.

Element 2: wherein the slickwater fracturing fluid further comprises an acidifying agent.

Element 3: wherein, within the subterranean formation, the one or more enzymes are capable of: promoting a reaction of kerogen or other organic matter, a formate, carbon dioxide (CO₂), or any combination thereof; dissolving or disintegrating kerogen or other organic matter; or any combination thereof.

Element 4: wherein the one or more enzymes comprise an enzyme selected from the group consisting of a laccase, a hydrolase, an oxoreductase, a lipase, and any combination thereof.

Element 5: wherein the one or more organisms belong to: a bacterial phylum selected from the group consisting of Actinobacteria, Pseudomonadota, Bacillota, and any combination thereof; a bacterial genus selected from the group consisting of Mycobacterium, Pseudomonas, Sphingomonas, Achromobacter, Bacillus, and any combination thereof; a fungal division selected from the group consisting of Basidiomycota, and any combination thereof; a fungal genus selected from the group consisting of Phanerochaete, Trametes, Bjerkandera, Pleurotus, and any combination thereof; or any combination thereof.

Element 6: wherein the slickwater fracturing fluid further comprises one or more oxidants capable of acting on kerogen or other organic matter within the subterranean formation.

Element 7: wherein the one or more oxidants comprise at least one oxidant selected from the group consisting of a peroxide, a persulfate, a chlorate, a bromate, a hypochlorite, a permanganate, and any combination thereof.

Element 8: wherein the slickwater fracturing fluid is introduced to the subterranean formation at a pressure and/or a flow rate sufficient to create and/or enlarge one or more fractures in the subterranean formation, and to force the slickwater fracturing fluid into the one or more fractures in the subterranean formation.

By way of non-limiting example, exemplary combinations applicable to A and B include any one, more, or all of Elements 1-8 in any combination.

The present disclosure is further directed to the following non-limiting embodiments.

Embodiment 1. A method comprising: introducing a slickwater fracturing fluid into a subterranean formation, wherein the slickwater fracturing fluid comprises: an aqueous fluid; one or more enzymes, one or more organisms capable of generating the one or more enzymes, or any combination thereof, wherein the one or more enzymes are capable of increasing hydrocarbon production from the subterranean formation; proppant particulates; a friction reducer; and optionally, one or more additives; and contacting the slickwater fracturing fluid with a matrix of the subterranean formation.

Embodiment 2. The method of Embodiment 1, wherein the one or more additives are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, and any combination thereof.

Embodiment 3 The method of Embodiment 1 or Embodiment 2, wherein the slickwater fracturing fluid further comprises an acidifying agent.

Embodiment 4 The method of any one of Embodiments 1-3, wherein, within the subterranean formation, the one or more enzymes are capable of: promoting a reaction of kerogen or other organic matter, a formate, carbon dioxide (CO₂), or any combination thereof; dissolving or disintegrating kerogen or other organic matter; or any combination thereof.

Embodiment 5 The method of any one of Embodiments 1-4, wherein the one or more enzymes comprise an enzyme selected from the group consisting of a laccase, a hydrolase, an oxoreductase, a lipase, and any combination thereof.

Embodiment 6 The method of any one of Embodiments 1-5, wherein the one or more organisms belong to: a bacterial phylum selected from the group consisting of Actinobacteria, Pseudomonadota, Bacillota, and any combination thereof; a bacterial genus selected from the group consisting of Mycobacterium, Pseudomonas, Sphingomonas, Achromobacter, Bacillus, and any combination thereof; a fungal division selected from the group consisting of Basidiomycota, and any combination thereof; a fungal genus selected from the group consisting of Phanerochaete, Trametes, Bjerkandera, Pleurotus, and any combination thereof; or any combination thereof.

Embodiment 7 The method of any one of Embodiments 1-6, wherein the slickwater fracturing fluid further comprises one or more oxidants capable of acting on kerogen or other organic matter within the subterranean formation.

Embodiment 8 The method of Embodiment 7, wherein the one or more oxidants comprise at least one oxidant selected from the group consisting of a peroxide, a persulfate, a chlorate, a bromate, a hypochlorite, a permanganate, and any combination thereof.

Embodiment 9 The method of Embodiment 1, wherein the slickwater fracturing fluid is introduced to the subterranean formation at a pressure and/or a flow rate sufficient to create and/or enlarge one or more fractures in the subterranean formation, and to force the slickwater fracturing fluid into the one or more fractures in the subterranean formation.

Embodiment 10 A slickwater fracturing fluid, comprising: an aqueous fluid; one or more enzymes, one or more organisms capable of generating the one or more enzymes, or any combination thereof, wherein the one or more enzymes are capable of increasing hydrocarbon production from a subterranean formation; proppant particulates; a friction reducer; and optionally, one or more additives.

Embodiment 11 The slickwater fracturing fluid of Embodiment 10, wherein the one or more additives are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, and any combination thereof.

Embodiment 12 The slickwater fracturing fluid of Embodiment 10 or Embodiment 11, wherein the slickwater fracturing fluid further comprises an acidifying agent.

Embodiment 13 The slickwater fracturing fluid of any one of Embodiments 10-12, wherein, within the subterranean formation, the one or more enzymes are capable of: promoting a reaction of kerogen or other organic matter, a formate, carbon dioxide (CO₂), or any combination thereof; dissolving or disintegrating kerogen or other organic matter; or any combination thereof.

Embodiment 14 The slickwater fracturing fluid of any one of Embodiments 10-13, wherein the one or more enzymes comprise an enzyme selected from the group consisting of a laccase, a hydrolase, an oxoreductase, a lipase, and any combination thereof.

Embodiment 15 The slickwater fracturing fluid of any one of Embodiments 10-14, wherein the one or more organisms belong to: a bacterial phylum selected from the group consisting of Actinobacteria, Pseudomonadota, Bacillota, and any combination thereof; a bacterial genus selected from the group consisting of Mycobacterium, Pseudomonas, Sphingomonas, Achromobacter, Bacillus, and any combination thereof; a fungal division selected from the group consisting of Basidiomycota, and any combination thereof; a fungal genus selected from the group consisting of Phanerochaete, Trametes, Bjerkandera, Pleurotus, and any combination thereof; or any combination thereof.

Embodiment 16 The slickwater fracturing fluid of any one of Embodiments 10-15, wherein the slickwater fracturing fluid further comprises one or more oxidants capable of acting on kerogen or other organic matter within the subterranean formation.

Embodiment 17 The slickwater fracturing fluid of Embodiment 16, wherein the one or more oxidants comprise at least one oxidant selected from the group consisting of a peroxide, a persulfate, a chlorate, a bromate, a hypochlorite, a permanganate, and any combination thereof.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method comprising:
introducing a slickwater fracturing fluid into a subterranean formation, wherein the slickwater fracturing fluid comprises:
an aqueous fluid;
one or more enzymes, one or more organisms capable of generating the one or more enzymes, or any combination thereof, wherein the one or more enzymes are capable of increasing hydrocarbon production from the subterranean formation;
proppant particulates;
a friction reducer; and
optionally, one or more additives; and
contacting the slickwater fracturing fluid with a matrix of the subterranean formation.

2. The method of claim 1, wherein the one or more additives are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, and any combination thereof.

3. The method of claim 1, wherein the slickwater fracturing fluid further comprises an acidifying agent.

4. The method of claim 1, wherein, within the subterranean formation, the one or more enzymes are capable of: promoting a reaction of kerogen or other organic matter, a formate, carbon dioxide (CO₂), or any combination thereof; dissolving or disintegrating kerogen or other organic matter; or any combination thereof.

5. The method of claim 1, wherein the one or more enzymes comprise an enzyme selected from the group consisting of a laccase, a hydrolase, an oxoreductase, a lipase, and any combination thereof.

6. The method of claim 1, wherein the one or more organisms belong to:
a bacterial phylum selected from the group consisting of Actinobacteria, Pseudomonadota, Bacillota, and any combination thereof;
a bacterial genus selected from the group consisting of Mycobacterium, Pseudomonas, Sphingomonas, Achromobacter, Bacillus, and any combination thereof;
a fungal division selected from the group consisting of Basidiomycota, and any combination thereof;
a fungal genus selected from the group consisting of Phanerochaete, Trametes, Bjerkandera, Pleurotus, and any combination thereof;
or any combination thereof.

7. The method of claim 1, wherein the slickwater fracturing fluid further comprises one or more oxidants capable of acting on kerogen or other organic matter within the subterranean formation.

8. The method of claim 7, wherein the one or more oxidants comprise at least one oxidant selected from the group consisting of a peroxide, a persulfate, a chlorate, a bromate, a hypochlorite, a permanganate, and any combination thereof.

9. The method of claim 1, wherein the slickwater fracturing fluid is introduced to the subterranean formation at a pressure and/or a flow rate sufficient to create and/or enlarge one or more fractures in the subterranean formation, and to force the slickwater fracturing fluid into the one or more fractures in the subterranean formation.

10. A slickwater fracturing fluid, comprising:
an aqueous fluid;
one or more enzymes, one or more organisms capable of generating the one or more enzymes, or any combination thereof, wherein the one or more enzymes are capable of increasing hydrocarbon production from a subterranean formation;
proppant particulates;
a friction reducer; and
optionally, one or more additives.

11. The slickwater fracturing fluid of claim 10, wherein the one or more additives are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, and any combination thereof.

12. The slickwater fracturing fluid of claim 10, wherein the slickwater fracturing fluid further comprises an acidifying agent.

13. The slickwater fracturing fluid of claim 10, wherein, within the subterranean formation, the one or more enzymes are capable of: promoting a reaction of kerogen or other organic matter, a formate, carbon dioxide (CO₂), or any combination thereof; dissolving or disintegrating kerogen or other organic matter; or any combination thereof.

14. The slickwater fracturing fluid of claim 10, wherein the one or more enzymes comprise an enzyme selected from the group consisting of a laccase, a hydrolase, an oxoreductase, a lipase, and any combination thereof.

15. The slickwater fracturing fluid of claim 10, wherein the one or more organisms belong to:
a bacterial phylum selected from the group consisting of Actinobacteria, Pseudomonadota, Bacillota, and any combination thereof;
a bacterial genus selected from the group consisting of Mycobacterium, Pseudomonas, Sphingomonas, Achromobacter, Bacillus, and any combination thereof;
a fungal division selected from the group consisting of Basidiomycota, and any combination thereof;
a fungal genus selected from the group consisting of Phanerochaete, Trametes, Bjerkandera, Pleurotus, and any combination thereof;
or any combination thereof.

16. The slickwater fracturing fluid of claim 10, wherein the slickwater fracturing fluid further comprises one or more oxidants capable of acting on kerogen or other organic matter within the subterranean formation.

17. The slickwater fracturing fluid of claim 16, wherein the one or more oxidants comprise at least one oxidant selected from the group consisting of a peroxide, a persulfate, a chlorate, a bromate, a hypochlorite, a permanganate, and any combination thereof.
